(19) United States
(12) Patent Application Publication
(10) Pub. No.: US 2026/0233770 A1
(43) Pub. Date: Aug. 13, 2026

(54) FOLDABLE MULTI-SHELF TROLLEY

(71) Applicant: IACOBUCCI HF AEROSPACE S.P.A., Ferentino (FR) (IT)

(72) Inventors: Lucio IACOBUCCI, Ferentino (FR) (IT); Antonino FONTANA, Ferentino (FR) (IT); Massimiliano JACOBUCCI, Ferentino (FR) (IT)

(73) Assignee: IACOBUCCI HF AEROSPACE S.P.A., Ferentino (FR) (IT)

(21) Appl. No.: 19/154,227

(22) PCT Filed: Feb. 6, 2024
(86) PCT No.: PCT/IB2024/051055

§ 371 Date: Aug. 6, 2025

(30) Foreign Application Priority Data
Feb. 6, 2023 (IT) 102023000001905

(51) Int. Cl. B62B 3/02

(52) U.S. Cl. CPC B62B 3/025; B62B 2205/02; B62B 2205/24; B62B 2205/33

(57) ABSTRACT

A foldable multi-shelf trolley including: a supporting structure, including two “U”-shaped tubular frames parallel to one another and spaced apart in a transverse direction Y-Y; a plurality of shelves, each including two half shelves coupled with the supporting structure so as to be able to move, in particular rotate, between a horizontal position, in which the respective shelf is formed in a trolley open configuration, and a vertical position, in which the half shelves of a shelf are arranged parallel to a vertical direction Z-Z and opposite in the transverse direction Y-Y, in a closed configuration of the trolley.

### BACKGROUND OF THE INVENTION

The object of this invention is a foldable multi-shelf trolley, in particular for use in particularly cramped environments, like for example in aircraft cabins, in trains, camper vans, caravans and mobile homes and for use in domestic environments, hotels, restaurants, cafes, the catering industry and care homes.

Trolleys are known that are movable on wheels and suitable for transporting a plurality of objects, that are for example used in a domestic and/or public environment like restaurants and shopping malls.

Foldable multi-shelf trolleys are also known that are able to move from an open configuration to a folded configuration to reduce the volumes thereof when not in use and vice versa.

One particular environment in which minimum overall dimensions of the trolley are required both in an open and closed condition but with great transporting capacity, is the cabins of aeroplanes in which the space available in the aisles between the seats and the service environments at the disposal of the crew are very reduced.

The technical problem therefore arises of devising a foldable multi-shelf trolley that is compact both when closed and open, that has great transporting capacity when open, but also compactness and ease of handling for use in particularly cramped environments.

Another part of this problem is moreover that the trolley needs to be easily operable in the opening and closing operations and have great safety for use in difficult environments like the cabins of aeroplanes or in trains, camper vans, caravans and mobile homes even in particular conditions of turbulence and movement.

The trolley then has to be cheap to produce and assemble and light in order not to unnecessarily increase the payload of aeroplanes.

### SUMMARY OF THE INVENTION

These results are obtained by the present invention from a foldable multi-shelf trolley according to the features of claim 1.

### BRIEF DESCRIPTION OF THE DRAWINGS

Further details can be obtained from the following description of a non-limiting example of an embodiment of the object of this invention made with reference to the enclosed drawings in which is shown:

in FIG. 1 a perspective view of the supporting structure of the trolley according to the invention;

in FIG. 2A a perspective view of the trolley of FIG. 1 fitted and in open configuration;

in FIG. 2B a perspective view of the trolley of FIG. 1 fitted and in open configuration;

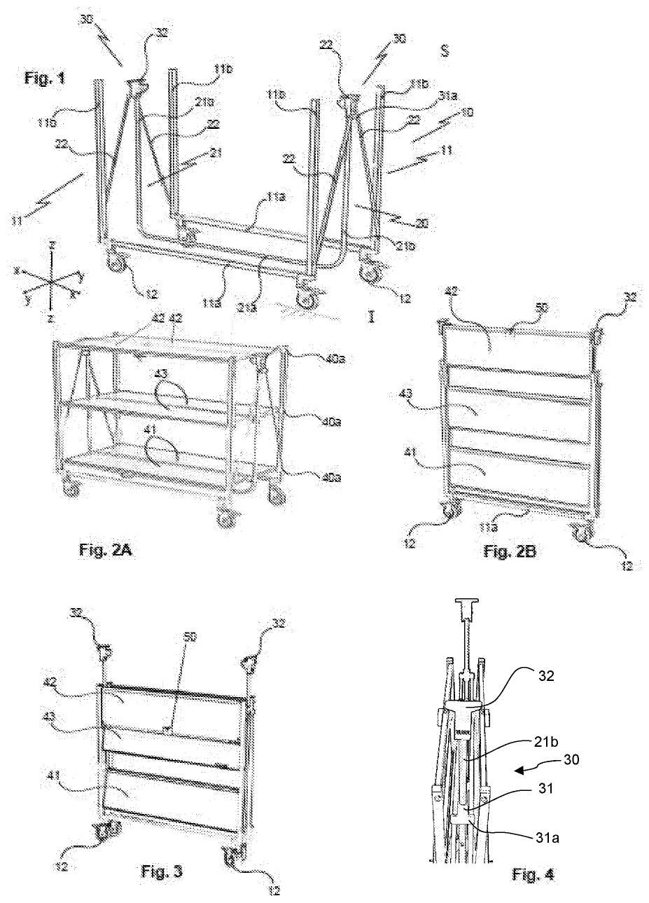

in FIG. 3 a perspective view of the trolley of FIG. 1 fitted and in an intermediate configuration, with upper half shelves in a vertical position facing outside;

in FIG. 4 a partial perspective view, from behind of the movement mechanism for switching the trolley between the open position and the closed position in the intermediate closing step of closing the trolley of FIG. 3;

in FIG. 5 a perspective detailed view, from in front, of the locking device for locking the shelves;

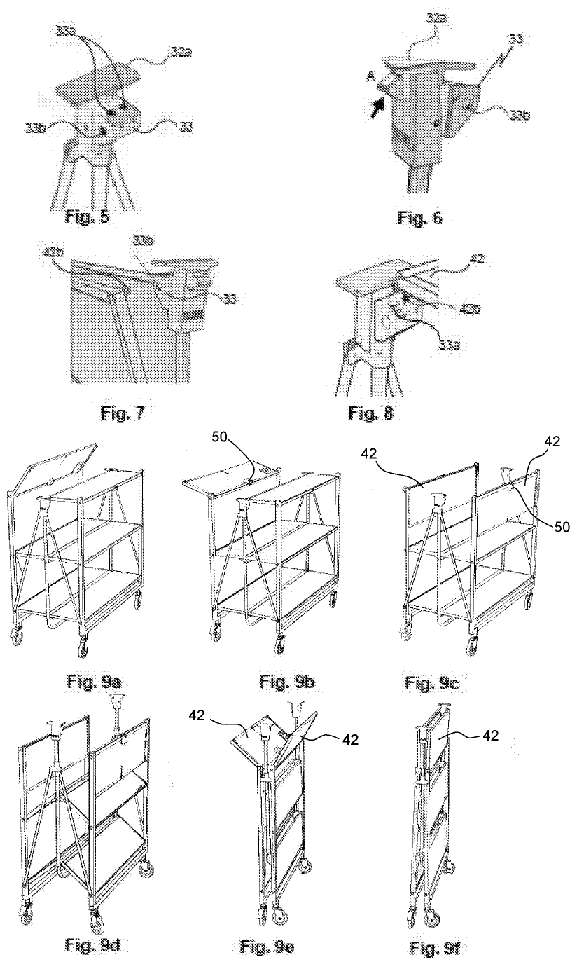

in FIG. 6 a perspective detailed view, from behind, of the locking device of FIG. 5;

in FIG. 7 a perspective view of the upper shelf of the trolley in the closing and locking step on the locking device;

in FIG. 8 a perspective view of the upper plane of the trolley in the step of opening the trolley and resting the trolley on the locking device and

in FIGS. 9a-9f the trolley closing sequence.

### DETAILED DESCRIPTION

As illustrated and assumed merely for ease of disclosure and without any limiting meaning, three references with directions that are respectively longitudinal X-X, corresponding to the length of the trolley; transverse Y-Y corresponding to the width of the trolley and to the opening/closing movements of the trolley; vertical Z-Z, orthogonal to the other two, and an upper part S and a lower part I opposite the previous one, resting on the ground, an embodiment of a trolley according to the invention includes:
a supporting structure 10, comprising two “U”-shaped tubular frames 11 parallel to one another and spaced apart in the transverse direction Y-Y, formed respectively by a horizontal base 11a and two vertical uprights 11b.

In one embodiment, at opposite ends of the bases 11a rotating wheels 12 or equivalent rolling elements are applied for moving the trolley, which can be provided with a pedal brake;
a plurality of shelves 40, in particular comprising two lower half shelves 41, two upper half shelves 42, and at least two intermediate half shelves 43, respectively suitable for forming a lower shelf, an upper shelf and at least one intermediate shelf, as in the illustrated embodiment having three-shelf.

As illustrated in FIGS. 2A, 2B, the half shelves 41, 42, 43 are coupled with the supporting structure 10 so as to be able to move, in particular rotate, between a horizontal position, in which the respective shelf is formed in a trolley open configuration, and a vertical position, in which the half shelves of a shelf are arranged parallel to a vertical direction Z-Z and opposite the transverse direction Y-Y, in a trolley closed configuration. In particular, each half-floor has pins 40a extending outwards from the respective opposite transverse sides to hinge on the uprights 11b of one of the frames 11 of the supporting structure 10.

As detectable, the frames 11 of the supporting structure 10 are in turn movable in the transverse direction between a corresponding spaced position, corresponding to the trolley open configuration (FIG. 2A) and a near position, corresponding to the trolley closed configuration (FIG. 2B).

As seen in FIG. 2B, in the closed configuration the half shelves 41, 42, 43 coupled with the same “U”-shaped frame 11 of the supporting structure are arranged substantially aligned along the same vertical plane, so that the trolley is extremely compact transversely when it is in the closed configuration.

For the open/closed switch of the trolley between the open configuration and the closed configuration a movement mechanism 20 is provided, which in the illustrated embodiment includes:
a third “U”-shaped frame 21, interposed in the transverse direction Y-Y between the two “U”-shaped frames 11 of the supporting structure 10, parallel thereto and comprising a horizontal base 21a and two vertical arms 21b. The third “U”-shaped frame is movable in the vertical direction Z-Z with respect to the two frames 11 of the supporting structure between a lowered position, which in the illustrated embodiment corresponds to the trolley closed configuration, and a raised position, which in the embodiment corresponds to the trolley open configuration;
two pairs of tie rods 22, each pair comprising a first tie rod, the lower end of which is hinged on a lower end of one of the respective vertical arms of a first of the “U”-shaped frames 11 and a second tie rod, the lower end of which is hinged on a lower end of one of the respective vertical arms of the other “U”-shaped frame 11;
a coupling and guide device 30 for coupling the tie rods 22 with the third “U”-shaped frame 21 allowing the relative movement thereof for the switching movement between the open configuration and the trolley closed configuration, including a pair of sleeves 31, which can be in upturned “T” form (FIG. 4), on the horizontal head 31a of which the upper ends of the tie rods 22 of each pair are respectively hinged. Each sleeve 31 has a hollow vertical shank 31b with a vertical axis that is inserted on a respective vertical arm 21b “U”-shaped frame 21 of the movement mechanism, to enable the vertical arm 21b to slide, as will be clearer below;
a gripping hook 32 constrained on the upper end of the vertical arm 21b of the movement “U” 21.

The two lower half shelves 41 and the two intermediate half shelves 43, which are respectively suitable for forming a lower shelf and an intermediate shelf, are hinged on the vertical arms 21b of the third “U”-shaped frame 21 of the movement mechanism, for example by respective flanges hinged on a longitudinal pin protruding inside the trolley from each of the vertical arms 21b of the “U”-shaped frame 21. Accordingly, the lower half shelves 41 and intermediate half shelves 43 are constrained to rotate with respect to the third frame 21 between the horizontal open position and the vertical closed position.

The upper half shelves 42 are on the other hand reversibly constrainable on the “U”-shaped frame 21 of the movement mechanism 20 by said positioning device 33a, 33b.

This enables the upper half shelves 42 to be detached from “U”-shaped frame 21 of the movement mechanism 20 so that it is suitable for rotating with respect to the respective “U”-shaped frame 11 of the supporting structure 10 between the vertical closed trolley position and a second vertical position (FIG. 3), turned towards the outside in the transverse direction by a further rotation of about 180° with respect to the upright 11b of the frame 11.

As will be clearer below, this second position facilitates switching movements of the configuration of the trolley.

In other words, the half shelves 42 that form the upper surface are separable from one another (each being able to rotate with respect to the respective frame 11) and are releasable from the third “U”-shaped frame 21.

In more detail, in the illustrated embodiment, the gripping hook 32 illustrated in FIGS. 5, 6 has a handle 32a that is integral with a body 33, protruding in the longitudinal direction X-X and towards the inside of the trolley, on which a pair of holes 33a are present with a vertical axis made on a horizontal surface, and a pair of holes 33b with a transverse axis made on the opposite vertical surfaces opposing the body 33, constituting an embodiment of positioning device for reversible fixing in position of the upper half shelves, respectively in the horizontal trolley open position and vertical trolley closed position.

The two upper half shelves 42 moreover have pins 42b extending outwards from the respective longitudinal long opposite sides and being suitable for insertion into one of the respective two holes 33a with a vertical axis of the body 33 (FIG. 8) in open trolley conditions, or in one of the respective two holes 33b with a horizontal axis of the body 33 in closed trolley conditions.

Almost each upper half shelf 42 can include one or more magnetic blocks 50 (FIGS. 9b, 9c) suitable for constraining one another to cause the upper half shelves to be locked in position in the vertical position and the trolley to be then locked correspondingly to the closed configuration thereof.

With the structure disclosed above the operation of the trolley is as follows: starting from the open trolley (FIG. 2A):
the two upper half shelves 42 are lifted and rotated outwardly (FIGS. 9a-9c) until taken to the second vertical position, turn to the outside and included between the arms 11b of the “U”-shaped frames of the support structure;
the gripping handles 32a are grasped by being pulled upwards, so as to slide the vertical arm 21b of the third “U”-shaped frame 21 of the movement mechanism 20 inside the respective hollow sleeve 31 (FIG. 9d);
the movement causes simultaneous rotation of the tie rods 22 around the head 31a of the sleeve 31 and around the lower end of the arms 11b of the two “U”-shaped tubular support frames, which rotation brings the two support frames 11 against one another in the transverse direction Y-Y, by rotating the lower and intermediate half shelves to the vertical position (FIG. 9e);
the two upper half shelves 42 rotate (FIG. 9f) in the opposite direction until taken to the vertical position, corresponding to the trolley closed configuration, with the pins 42b that, inserted into the holes 33b with a horizontal axis of the body 33 of the gripping handle, maintain correct positioning of the upper half shelves (FIG. 9e);
the rotation takes the magnetic blocks 50 to hook up together to lock the trolley in a closed position (FIG. 9f).

To open the trolley, the opposite sequence is followed until the trolley opens completely as illustrated in FIG. 2A, with the pins 42b of the upper half shelves that are inserted into the holes 33a with a vertical axis of the body 33, reversibly constraining the position of the half shelves and thus the trolley open configuration.

According to the embodiments, the trolley is made entirely of light materials like aluminium so as to minimize the overall weight of the assembly.

As illustrated in FIGS. 8, 9a-9c, the coupling and guide sleeve in the form of an upturned T 31 is suitable for further constituting a stroke stop in the lowered open trolley position for vertical sliding of the third “U”-shaped frame 21, by contact with the positioning body 33, so that the body 33 and the sleeve 31 form a further positioning and locking device for positioning and locking the trolley open configuration.

The trolley according to the invention is thus extremely compact in both the closed and open configurations and has great safety for use in difficult and/or cramped environments like for example aeroplane cabins, in trains, camper vans, caravans and mobile homes, and for use in domestic environments, hotels, restaurants, cafes, the catering industry and care homes. The trolley enables a desired number of shelves of the same and great capacity to be made. The trolley is moreover very safe in performing trolley opening/closing operations, with stable maintenance of the closing and opening configurations even in particular turbulence or movement conditions.

It is further shown that the reduced number of operations for moving from the open configuration to the closed configuration result in easy and fast use even in the cramped environments of aeroplanes, with simplified operations that are within the reach of any, even non-qualified user.

Although disclosed in the context of some embodiments and of some examples of implementation of the invention, the scope of protection of this patent is defined only by the claims below.

1-14. (canceled)

15. A foldable multi-shelf trolley including:
a supporting structure, including two “U”-shaped tubular frames parallel to one another and spaced apart in a transverse direction;
a plurality of shelves, each including two half shelves coupled with the supporting structure so as to be able to move between a horizontal position, in which they form the respective shelf in a trolley open configuration, and a vertical position, in which the half shelves of a shelf are arranged parallel to a vertical direction and opposite each other in the transverse direction, in a trolley closed configuration;
a movement mechanism for switching the trolley between the open position and the closed position, comprising a third “U”-shaped frame, interposed in the transverse direction between the two “U”-shaped frames of the supporting structure and movable in the vertical direction with respect to the two frames of the supporting structure between a raised position and a lowered position;
wherein the half shelves forming an upper shelf of the plurality of shelves are separable from one another and detachable from the third “U”-shaped frame and in that the upper half shelves are configured to rotate with respect to the respective “U”-shaped frame of the supporting structure between the vertical position of the trolley closed configuration and a second vertical position, turned towards the outside in the transverse direction.

16. The trolley according to claim 15, wherein the movement mechanism for switching the trolley between the open position and the closed position includes:
tie rods coupled with the “U”-shaped frames of the supporting structure;
a coupling and guide device for coupling the tie rods with the third “U”-shaped frame allowing the relative movement thereof for switching between the open configuration and the trolley closed configuration.

17. The trolley according to claim 15, further including a positioning and locking device for positioning and locking the half shelves in the trolley open and closed configurations.

18. The trolley according to claim 15, including a gripping element for moving the third “U”-shaped frame in the vertical direction.

19. The trolley according to claim 15, wherein the two “U”-shaped tubular frames of the supporting structure and/or the third “U”-shaped frame of the movement mechanism each include a horizontal base and two vertical uprights oppositely arranged in a longitudinal direction.

20. The trolley according to claim 15, wherein in the trolley closed configuration the “U”-shaped frame of the movement mechanism is in the raised position, and in the trolley open configuration the “U”-shaped frame is in the lowered position.

21. The trolley according to claim 15, including two pairs of the tie rods, each pair including a first tie rod, the lower end of which is hinged on a lower end of a respective one of the vertical arms of a first of the “U”-shaped frames of the supporting structure and a second tie rod, the lower end of which is hinged on a lower end of a respective upright of the vertical uprights of the other “U”-shaped frame.

22. The trolley according to claim 15, wherein the coupling and guide device includes a pair of sleeves, in the form of an upturned T, the upper ends of the first and of the second tie rod of a respective pair of tie rods being respectively hinged on each sleeve; wherein each sleeve has a hollow shank with a vertical axis into which a respective vertical arm of the third “U”-shaped frame of the movement mechanism is slidingly inserted.

23. The trolley according to claim 15, wherein the plurality of shelves includes two lower half shelves and two upper half shelves, respectively suitable for forming a lower shelf and an upper shelf, wherein the lower half shelves are hinged on the third “U”-shaped frame of the movement mechanism and the upper half shelves are reversibly constrainable with the third “U”-shaped frame of the movement mechanism by the positioning device; and wherein, optionally, the plurality of shelves includes at least two intermediate half shelves suitable for forming a respective intermediate shelf, the intermediate half shelves being hinged on the third “U”-shaped frame of the movement mechanism.

24. The trolley according to claim 15, including rolling elements fixed to the supporting structure to enable the trolley to be moved.

25. The trolley according to claim 17, wherein the positioning and locking device includes a respective body, constrained on each of the vertical uprights of the third “U”-shaped frame and protruding in the longitudinal direction to the inside of the trolley, a pair of holes being present on the body with a vertical axis and/or a pair of holes with a transverse axis suitable for receiving respective pins protruding from the upper half shelves for the reversible constraining in position of the upper half shelves, respectively in the horizontal open position and vertical closed position of the trolley.

26. The trolley according to claim 15, wherein, in the trolley closed configuration, the half shelves coupled with the same “U”-shaped frame of the supporting structure are arranged substantially aligned along the same vertical plane.

27. The trolley according to claim 17, wherein the positioning and locking device includes one or more magnetic blocks arranged at least on each of two upper half shelves and suitable for being constrained on one another to cause the upper half shelves to lock in the vertical position and the trolley to be locked correspondingly in the closed configuration.

28. A method comprising transporting items via the trolley according to claim 15 in aeroplanes, trains, camper vans, caravans and mobile homes, for use in domestic environments, hotels, restaurants, cafés, the catering industry and care homes.

29. The trolley according to claim 16, further including a positioning and locking device for positioning and locking the half shelves in the trolley open and closed configurations.

30. The trolley according to claim 16, including a gripping element for moving the third “U”-shaped frame in the vertical direction.

31. The trolley according to claim 17, including a gripping element for moving the third “U”-shaped frame in the vertical direction.

32. The trolley according to claim 29, including a gripping element for moving the third “U”-shaped frame in the vertical direction.

33. The trolley according to claim 29, wherein the positioning and locking device includes a respective body, constrained on each of the vertical uprights of the third “U”-shaped frame and protruding in the longitudinal direction to the inside of the trolley, a pair of holes being present on the body with a vertical axis and/or a pair of holes with a transverse axis suitable for receiving respective pins protruding from the upper half shelves for the reversible constraining in position of the upper half shelves, respectively in the horizontal open position and vertical closed position of the trolley.

34. The trolley according to claim 29, wherein the positioning and locking device includes one or more magnetic blocks arranged at least on each of two upper half shelves and suitable for being constrained on one another to cause the upper half shelves to lock in the vertical position and the trolley to be locked correspondingly in the closed configuration.
